(19) United States
(12) Patent Application Publication
(10) Pub. No.: US 2005/0088348 A1
(43) Pub. Date: Apr. 28, 2005

(54) Driven arrray dual-band linear antenna

(76) Inventors: Hsiang-Jung Chi, Shenkeng Township (TW); Cho-Chin Chen, Shenkeng Township (TW)

Correspondence Address: Yi-Wen Tseng, 509 ROOSEVELT BLVD. #D306, FALL CHURCH, VA, 22044, US

(21) Appl. No.: 10/692,844

(22) Filed: Oct. 27, 2003

(51) Int. Cl. H01Q 1/24

(52) U.S. Cl. 343/702

(57) ABSTRACT

A driven array dual band linear antenna, having a radiator constructed by four metal plates with the same length and width is disclosed. The metal plates arranged as a parallelepiped array, and the length of each metal plate is one half of the wavelength of a low frequency electric wave transmitted and received by the antenna.

### BACKGROUND OF THE INVENTION

The present invention relates to a driven array dual-band linear antenna, and more particular, to a driven array dual-band linear antenna formed by four half-wave antenna members arranged as an array.

To comply with the popularity of portable electric products, wireless communication technology has been highly developed in recent years. The wireless communication devices typically require two bands for signal transmission and reception. For example, for the very popular wireless local area network (WLAN), the operation frequency band of access point (AP) and wireless local network card are 2.4-2.5 GHz and 4.9-5.85 GHz, respectively, according to IEEE 802.11a, b, g. Therefore, a dual-band antenna has to be used for best performance.

In the wireless local network as mentioned above, the wireless network normally use an internal antenna, while external antenna is typically adapted by the access point. FIG. 1 shows a conventional dual-band antenna used in the access point. As shown, a radiator is constructed by a copper foil A1 formed on a printed circuit board A to serves as a planar antenna. This transmission and reception of electric wave for planar antenna is typically very directive. Therefore, good transmission and reception can be obtained in the fan area encompassed by two orthogonal lines of the plane. In contrast, the transmission and reception are poor along the extension of the plane, that is, the area parallel to the plane. Further, radiation of electric wave is affected by the substrate material at the rear side of the substrate opposing to the copper foil. Therefore, two planar antennas have been back-to-back connected for form a dual-side printed antenna. However, this still cannot provide a full-angle radiation, and a dead angel for radiation still exists.

### BRIEF SUMMARY OF THE INVENTION

The present invention provides a driven array dual-band linear antenna with omni-directional transmission and reception for electric wave. The antenna does not have dead angle for radio transmission and reception. More importantly, the antenna can be fabricated with simple process and low cost.

The driven array dual-band linear antenna provided by the present invention comprises a radiator formed by four metal plates arranged as a parallelepiped array, wherein the metal plates have the same length and width, and the length of each metal plate is one half of the wavelength of a low frequency electric wave transmitted and received by the antenna.

The present invention further provides a driven array dual-band linear antenna, comprising a radiator formed by a plurality of conductive plates arranged side-by-side as a three-dimensional polygonal array, wherein the sides of the plates are not in contact with each other, and the lower edges of the conductive plates are connected to a feed point in series.

### BRIEF DESCRIPTION OF THE DRAWINGS

These, as well as other features of the present invention, will become apparent upon reference to the drawings wherein:

FIG. 1 shows a conventional dual-band planar antenna;

FIG. 2 shows a perspective view of the driven array dual-band linear antenna; and

FIG. 3 shows a top view of FIG. 2.

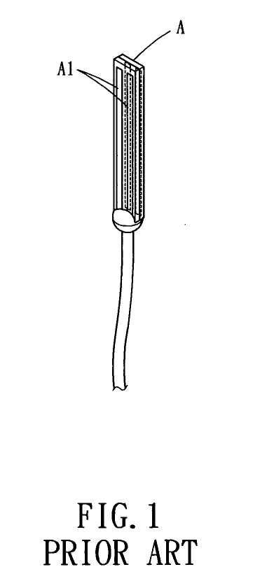

### DETAILED DESCRIPTION OF THE INVENTION

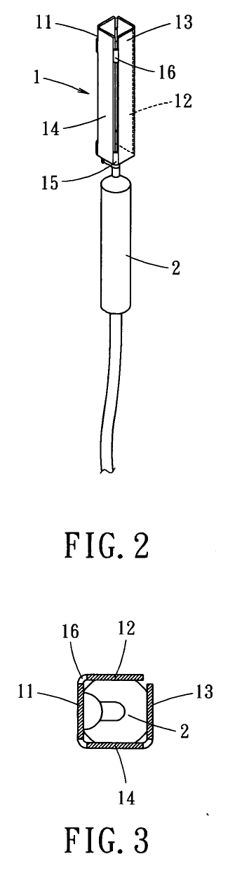

FIGS. 2 and 3 depict a perspective view and a top view of a driven array dual-band linear antenna provided by the present invention. As shown, the antenna includes a radiator 1 constructed by four rectangular metal plates 11, 12, 13 and 14. Each of the metal plates 11-14 is fabricated from conductive material such as iron or copper. The metal plates 11-14 have the same length and width and arranged as a parallelepiped array. The parallelepiped array includes a bottom plate 15 connected to lower edges of the metal plates 11-14. The side edges of the neighboring metal plates 11-14 are spaced from each other by a gap. As the side edges of the metal plates 11-14 are not connected to each other, a connecting member 16 is applied to interconnect upper portions of the side edges of metal plates 11-14. The metal plates 11-14 are thus properly positioned by the bottom plate 15 and the connecting member 16. Via the bottom plate 15, the roots, that is, the lower edges, of the metal plates 11-14 are serially connected to a signal feed point. A signal coaxial cable connected to the signal feed point includes an external copper tube 2. The length of each metal plate 11-14 is half of the wavelength of the low frequency (2.4-2.5 GHz) transmitted and received by the antenna. By the array formed by four half-wave antenna members 11-14, a second frequency domain (4.9-5.85 GHz), which is the high frequency, is generated. The length of the metal plates 11-14 depends on the fabrication material, width and gap between the neighboring metal plates. The antenna provided by the present invention provide omni-direction transmission and reception for a low frequency and a high frequency double the low frequency to eliminate the dead angle transmission and reception, so as to improve gain of the antenna.

The present invention provides a parallelepiped antenna constructed by four antenna members. It will be appreciated that other three-dimensional configuration constructed by various number of antenna members can also be formed based on the same principle of the present invention.

According to the above, the present invention uses the concept of driven array antenna to generate half-wave antenna members spaced from each other by slots to increase bandwidth of frequency domain. The simple structure successfully establishes an omni-directional radiation field with improved bandwidth. This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. A driven array dual-band linear antenna, comprising a radiator formed by four metal plates arranged as a parallelepiped array, wherein the metal plates have the same length and width, and the length of each metal plate is one half of the wavelength of a low frequency electric wave transmitted and received by the antenna.

2. The antenna according to claim 1, wherein the radiator further comprises a bottom plate for connecting lower edges of the metal plates to a signal feed point.

3. The antenna according to claim 1, wherein the radiator further comprises a connecting members connecting side edges of the neighboring metal plates.

4. The antenna according to claim 3, wherein the signal feed point is connected to a coaxial cable of which a ground signal is connected to a copper tube.

5. The antenna according to claim 1, wherein the metal plates are conductive plates.

6. The antenna according to claim 1, wherein the metal plates are fabricated from iron or copper.

7. The antenna according to claim 1, wherein side edges of the neighboring metal plates are spaced from each other by a gap.

8. The antenna according to claim 1, wherein low and high operation frequencies of the radiator are 2.4-2.5 GHz and 4.9-5.85 GHz, respectively.

9. A driven array dual-band linear antenna, comprising a radiator formed by a plurality of conductive plates arranged side-by-side as a three-dimensional polygonal array, wherein the sides of the plates are not in contact with each other, and the lower edges of the conductive plates are connected to a feed point in series.
